(19) United States
(12) Patent Application Publication
(10) Pub. No.: US 2014/0007840 A1
(43) Pub. Date: Jan. 9, 2014

(54) CARBURETORS FOR PROVIDING AIR-TO-FUEL RATIO VARIABILITY INDEPENDENT OF ENGINE LOAD

(71) Applicants: James M. Cleeves, Redwood City, CA (US); Simon David Jackson, Redwood City, CA (US)

(72) Inventors: James M. Cleeves, Redwood City, CA (US); Simon David Jackson, Redwood City, CA (US)

(21) Appl. No.: 13/938,087

(22) Filed: Jul. 9, 2013

Related U.S. Application Data
(60) Provisional application No. 61/669,597, filed on Jul. 9, 2012.

(51) Int. Cl. F02M 7/24

(52) U.S. Cl. CPC F02M 7/24
USPC 123/438; 261/64.1

(57) ABSTRACT

Carburetor features, which can include but are not limited to varying slope angles in different sections of a multi-sectioned carburetor needle, can provide combustion mixtures to an engine that include a fuel-air ratio that is variable independent of the rate of air flow through the carburetor. Related methods, systems, articles of manufacture, etc. are described.

### CROSS-REFERENCE TO RELATED APPLICATION

This application claims priority to U.S. Provisional Application No. 61/669,597, which was filed on Jul. 9, 2013. The disclosure of the priority application and any other documents referenced herein are incorporated by reference to the extent possible under applicable laws unless otherwise stated.

### TECHNICAL FIELD

The subject matter described herein relates to internal combustion engines, and in particular, to internal combustion engine systems, methods, components, and the like that are capable of providing dynamically controlled combustion mixtures.

### BACKGROUND

Internal combustion engines are commonly used to provide power for motor vehicles as well as in other applications, such as for example for lawn mowers and other agricultural and landscaping equipment, power generators, pump motors, boats, planes, and the like. For a typical driving cycle of a motor vehicle, the majority of fuel consumption may occur during low-load and idling operation of the vehicle's internal combustion engine. Similarly, other uses of internal combustion engine may also be characterized by more frequent use at a power output less than that provided at a wide open throttle condition. However, due to mechanical friction, heat transfer, throttling, and other factors that can negatively impact performance, spark ignition internal combustion engines inherently have better efficiency at high loads and poorer efficiency at low loads.

Conventional internal combustion engines typically use a combustion mixture having an air-to-fuel ratio that is relatively constantly proportional to the load on the engine. In some other conventional engines, the air-to-fuel ratio of the combustion mixture can approximately monotonically decrease with increasing load. In contrast, some recently developed engines, such as for example those described in international patent publication no. WO2011/112735 (“Multi-Mode High Efficiency Internal Combustion Engine”), can require more continuous and detailed control over the air-to-fuel ratio of the combustion mixture. In some examples, the combustion mixture can be very lean (e.g. a high air-to-fuel ratio) at light loads and approximately stoichiometric or even richer than stoichiometric at higher loads. Examples of some carburetor designs that can achieve at least some of the air-to-fuel ratio controls consistent with operation of such engines are also described in international patent publication no. WO/2012/048311 (“Control of Combustion Mixtures and Variability thereof with Engine Load”).

Many currently available small engines, such as for example those used in motorcycles and other small vehicles, include a slide style carburetor or a constant velocity style carburetor. A constant velocity carburetor is one in which air flow through the carburetor is controlled by a throttle valve, typically a butterfly valve, that opens and closes under control of a throttle input (e.g. a throttle cable from a pedal control, a grip control, or the like). The incoming air flows through a Venturi throat region in which the cross-sectional area of the air passage is reduced to cause the air velocity to increase and the air pressure to decrease. A fuel reservoir is connected to the Venturi throat region via a fuel discharge nozzle connected to a calibrated orifice or jet that allows a consistent amount of fuel to flow at a given pressure difference between the discharge nozzle and a second pressure conveying tube connecting the fuel reservoir to the air passage upstream of the venture throat. The pressure difference between the Venturi throat region and the upstream part of the air passage varies with the air flow and dictates that an amount of fuel is delivered to the air in the Venturi throat region to maintain a relatively constant air-to-fuel ratio. Higher air flow rates lead to larger pressure differences across the calibrated orifice or jet, which increases the amount of fuel being delivered into the larger amount of air.

In a slide carburetor, for example the carburetor 100 shown in FIG. 1, the air flow rate is controlled by motion of a slide apparatus 102 that moves approximately perpendicularly to the direction of air flow. The motion of the slide 102 can be controlled directly by the throttle control device (e.g. pedal, grip, etc.), for example by action of a cable 104 from the throttle control. A needle 106 having a tip end 108 can be attached to the slide 102 at an attached end 109. When the throttle is open, the needle 106 is raised up out of the jet or orifice 110 (hereinafter referred to as a fuel orifice) to allow more fuel to flow from the fuel reservoir 112 mix with increased air flow passing through the larger opening provided by the rising slide 102. In conventional carburetors, the needle typically includes a constant or near constant slope angle between the tip end 108 and the attached end 109. Slope angle in this context refers to an angle formed by an outer surface of the needle 106 relative to the central axis.

### SUMMARY

Implementations of the current subject matter can, among other possible advantages, provide systems, methods, techniques, etc. to achieve control of an air-to-fuel ratio of a combustion mixture independently of air flow through a slide carburetor. In this manner, a more complex relationship between combustion mixture richness and engine load can be achieved.

In one aspect, a system includes a carburetor needle that includes a plurality of longitudinal sections and that has a tip end. The plurality of longitudinal sections include a first section having a first slope angle relative to a central axis of the needle, a second section having a second slope angle relative to a central axis of the needle, and a third section having a third slope angle relative to a central axis of the needle. The first slope angle gives the first section a first cross sectional area that is either substantially constant with distance along the central axis or increasing in a direction of the tip end. The second slope angle causes the second section to taper with distance along the central axis toward the tip end, and the third slope angle causes the third section to taper more rapidly than the second section with distance along the central axis toward the tip end. The system further includes a mechanism for moving the carburetor needle into and out of a fuel orifice such that the first section is positioned in the orifice during an idle condition of an internal combustion engine, the second section is positioned in the orifice for engine operation up to a threshold throttle position, and the third section is positioned in the orifice for engine operation between the threshold throttle position and a fully open throttle position.

In an interrelated aspect, a method includes moving a carburetor needle to position a first section of the carburetor needle within an orifice during an idle condition of an internal combustion engine, moving the carburetor needle to position a second section of the carburetor needle within the orifice during engine operation up to a threshold throttle position of a throttle, and moving the carburetor needle to position a third section of the carburetor needle within the orifice during engine operation between the threshold throttle position and a fully open throttle position. The first section includes a first slope angle relative to a central axis of the carburetor needle. The first slope angle gives the first section a first cross sectional area that is either substantially constant with distance along the central axis or increasing in a direction of a tip end of the carburetor needle. The second section includes a second slope angle relative to the central axis of the carburetor needle. The second slope angle causes the second section to taper with distance along the central axis toward the tip end. The third section includes a third slope angle relative to the central axis of the carburetor needle. The third slope angle causes the third section to taper more rapidly than the second section with distance along the central axis toward the tip end.

In some variations, one or more of the following features can optionally be included in any feasible combination. The threshold throttle position can occur when the throttle is approximately 80% open. A first combustion mixture having an approximately stoichiometric fuel-air ratio is can be provided when the first section is positioned in the orifice, a second combustion mixture having a second fuel-air ratio that becomes progressively more lean with increased throttle opening can be provided when the second section is positioned in the orifice, and a third combustion mixture having a third fuel-air ratio that becomes progressively richer with increased throttle opening can be provided when the third section is positioned in the orifice.

A feedback mechanism can indicate to a user that the third section of the carburetor needle is positioned in the orifice and that the internal combustion engine is operating in a less efficient mode than when the second section is positioned in the orifice. The mechanism for moving the carburetor needle can include a slide that moves away from the orifice to increase air flow passing over the orifice and toward the orifice to reduce air flow passing over the orifice. An attached end of the carburetor needle that is disposed opposite the tip end can be attached to the slide. The slide can be moveable past a position providing full throttle air flow passing over the orifice such that the carburetor needle is drawn farther out of the orifice and such that the third section of the carburetor needle is positioned in the orifice. The mechanism for moving the carburetor needle can include a slide, and the needle can be attached to the slide such that the needle is at least partially retractable into the slide. The mechanism can further include a spring that exerts a biasing force on the carburetor needle in a direction toward the orifice and a control apparatus that exerts additional force on the carburetor needle such that the biasing force is overcome for engine operation past the threshold throttle position.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The details of one or more variations of the subject matter described herein are set forth in the accompanying drawings and the description below. Other features and advantages of the subject matter described herein will be apparent from the description and drawings, and from the claims. The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram showing an example of conventional slide carburetor configuration;

FIG. 2 is a diagram showing an example of a sectioned carburetor needle having different slopes in different sections consistent with implementations of the current subject matter;

FIG. 3A, FIG. 3B, and FIG. 3C are diagrams showing an example of a first carburetor configuration consistent with implementations of the current subject matter;

FIG. 4A and FIG. 4B are diagrams showing an example of a second carburetor configuration consistent with implementations of the current subject matter; and

FIG. 5 shows a process flow diagram illustrating features of a method consistent with implementations of the current subject matter.

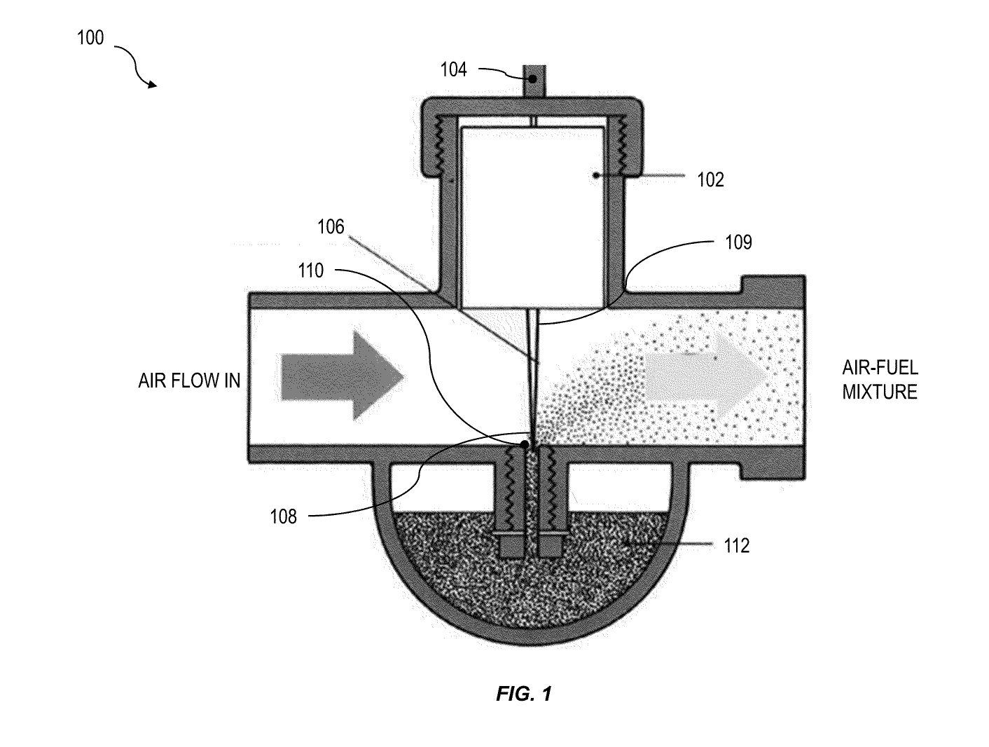

When practical, similar reference numbers denote similar structures, features, or elements.

### DETAILED DESCRIPTION

Carburetors in current use in internal combustion engines are generally incapable of adjusting the delivered fuel-air ratio independent of the load on the engine. With a typical carburetor, a high airflow provides high power, while a lower air flow provides lower power. The fuel-air ratio delivered by the carburetor varies with the air flow rate. However, control of the fuel-air ratio independent of the airflow rate is generally not possible. Independent control of the fuel-air ratio and the airflow rate is necessary for engines requiring a rich mixture at low speed but high load, which is a relatively low air flow condition, while requiring a leaner mixture at high engine speed and low load, which is a high air flow condition under which a conventional carburetor would typically provide a richer mixture.

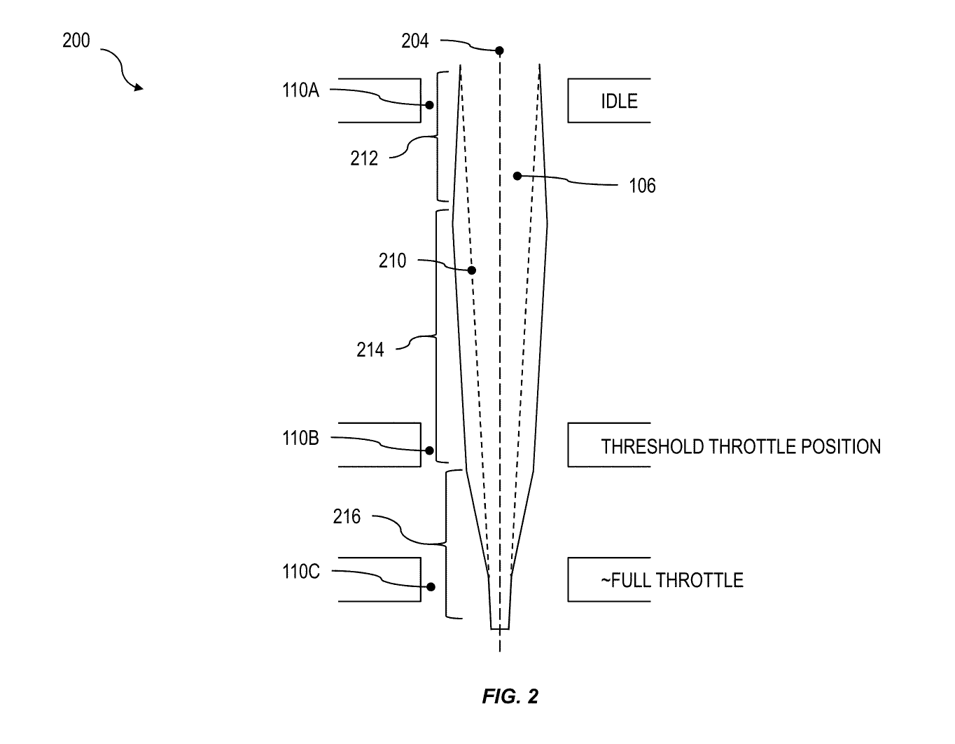

In one implementation of the current subject matter shown in the diagram 200 of FIG. 2 a needle 106 can have multiple sections arranged along its central axis 204. One or more of these sections can have a different slope angle relative to the central axis 204. Slope angle in this context refers to an angle formed by an outer surface of the needle 106 relative to the central axis 204. The diagram 200 shows the needle 106 in three different positions relative to the fuel orifice 110A, 110B, 110C. For example, the needle is position relative to the fuel orifice 110A as it would be for an idle condition, relative to the fuel orifice 110B as it would be during operation of the engine up to a threshold position of the throttle (e.g. approximately 80%, although other throttle threshold positions than 80% are also within the scope of the current subject matter), and relative to the fuel orifice 110C as it would be during operation of the engine beyond the threshold position of the throttle. As depicted in FIG. 2, the needle 106 moves in an upward direction (e.g. to withdraw more of the needle from the orifice 110) with increasing throttle. A mechanism, which can in various implementations include a slide 102 and/or other structural elements, can be coupled to the attached end 109 of the carburetor needle. This mechanism can cause movement of the carburetor needle into and out of the orifice 110. It should be noted that a carburetor needle 106 as described herein need no be fixed to a slide 102. In other words motion of the carburetor needle can occur with or without equivalent motion of a slide 102.

A constant slope needle profile 210 is shown in the diagrams 200, 230, 260 by two dashed lines. Consistent with implementations of the current subject matter first section 212 of the needle 106 can have a first slope angle, which can optionally be inclined such that the first section has a cross-sectional area that is substantially constant with distance along the axis 204 or that increases in the direction of the tip end 108 of the needle 106. As noted above, the first section is positioned in the orifice 110 when the engine is at idle. In this manner, a first combustion mixture that is close to a stoichiometric fuel-air ratio can be provided for smooth running at idle.

A second section 214 of the needle can have a second slope angle, which can generally taper (i.e. trend from a larger cross sectional area to a smaller cross section area) as the tip end 108 of the needle 106 is approached. When the needle 106 is positioned with the second section 214 in the fuel orifice 110, a second combustion mixture can be provided that becomes progressively more lean (i.e. progressively more excess air is provided in the combustion mixture relative to the stoichiometric fuel-air ratio) with increased throttle opening until the throttle reaches a threshold position, which can in some examples be approximately 80% open.

A third section 216 of the needle 106 can include an increased taper of the slope angle relative to the second section 214 such that when the third section 216 of the needle is in the fuel orifice 110, the produced combustion mixture of air and fuel becomes progressively richer (i.e. progressively less excess air is provided relative to the stoichiometric fuel-air ratio and the combustion mixture can optionally transition from an excess air condition relative to the stoichiometric fuel-air ratio to an excess fuel condition relative to the stoichiometric fuel-air ratio). In an example, the third fuel-air ratio occurring while the third section is positioned in the orifice 110 can range from a lean fuel-air ratio (e.g. approximately 40% excess air) at the threshold position of the throttle to a rich fuel-air ratio (e.g. approximately 15% excess fuel) at a full (e.g. wide open) throttle position.

In a fuel injected system in which fuel flow is completely independent of the air flow and can be controlled by electronics, the fuel flow can be kept proportional to the air flow until the throttle is wide open and then increased to cause a richer combustion mixture. However, this effect is more difficult to achieve with a carburetor. Use of a carburetor needle 106 having one or more characteristics consistent with FIG. 2 and the descriptions thereof can achieve an approximation of this capability without requiring a computerized engine control unit, fuel injectors, or the like.

The air flow does not increase nor do the pumping losses decrease very rapidly as the throttle is opened from 80% to 100%. As an illustration of this effect, when the throttle opens from 10% to 30%, the change in cross-sectional flow area is 200%. In contrast, when the throttle changes from 80% to 100%, the change in cross-sectional flow area is only 25%. Accordingly, the power supplied by an engine normally changes slowly for throttle changes at large throttle openings compared to a similar change in throttle opening for a small throttle opening. In addition, carburetors and throttle bodies are typically sized so that the restriction at full throttle is minimum. When the restriction is at a minimum, the additional restriction for a small reduction in cross-sectional flow area provided by the throttle is relatively small. A butterfly throttle is a little different in that even larger fractional changes occur at very small throttle angles. However, when the throttle is near full open, the restriction at the throat of the carburetor will be the controlling restriction. As such, almost no power change happens in a conventional engine between 80% and 100% movement on a throttle.

Consistent with implementations of the current subject matter, a small amount of additional power that might have been available in a lean (e.g. more efficient) operating regime at the highest throttle settings for a conventional engine can be “traded” for the ability to achieve an improved maximum power at throttle settings between the threshold throttle position and 100% throttle. In this manner, a first “maximum” power can be achieved at the threshold throttle position, which can correspond to a maximum carburetor needle position with the second section 214 still in the fuel orifice 110. This first “maximum” power can be achieved in a lean combustion mixture regime that can provide relatively high efficiency. Travel of the throttle position beyond the threshold position can provide an increasing rich combustion mixture with relatively little increase in the total air flow. The richer mixture thereby allows for the engine to achieve a greater maximum power than the first “maximum” power achievable at the threshold throttle position. A lower efficiency of the engine occurs for operation with the third section 216 of the needle 106 in the fuel orifice 110 than with the second section 214 in the fuel orifice 110. However, as the extra power provided with the third section 216 of the needle 106 in the fuel orifice 110 is typically needed only sporadically in normal drive cycle usage of a vehicle, the overall efficiency of the engine over an entire drive cycle is improved.

Consistent with some implementations of the current subject matter, a feedback (tactile, visual, audio, etc.) can be provided to the operator to indicate that the engine has begun to transition from a more efficient mode to a higher power, lower efficiency mode as the third section 216 of the needle 106 is brought into cooperation with the fuel orifice. The feedback can be provide by a feedback mechanism, such as for example an extra spring that gives more resistance when the slide is lifted over the last 20% of its travel distance. Alternatively or in addition, other types of feedback mechanisms and feedback can be used.

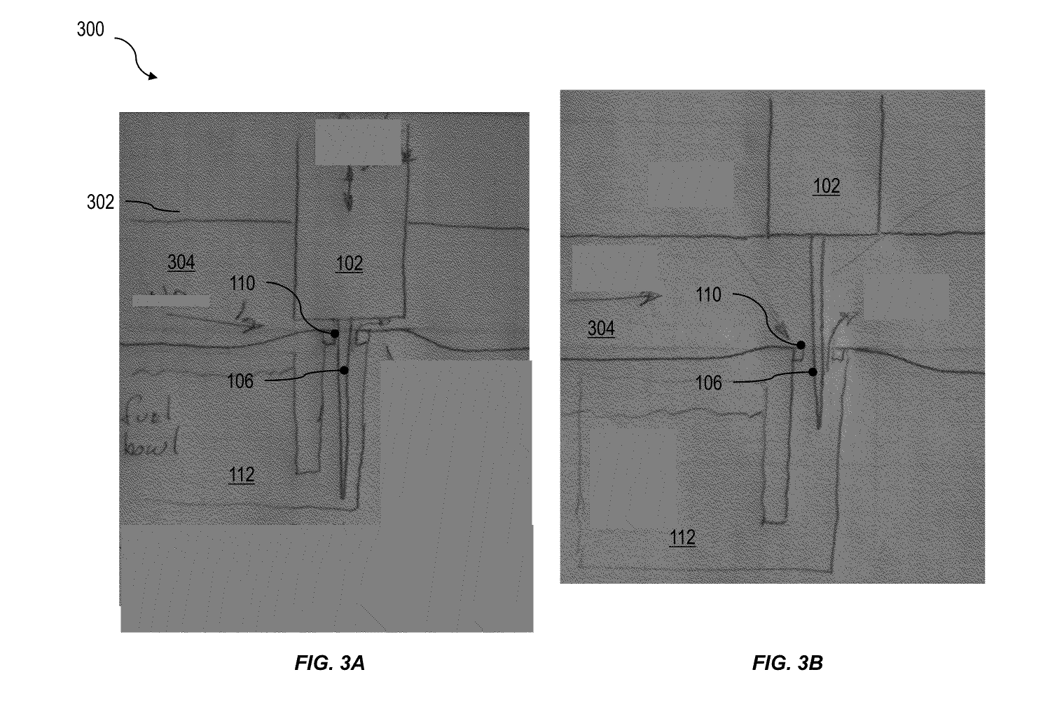

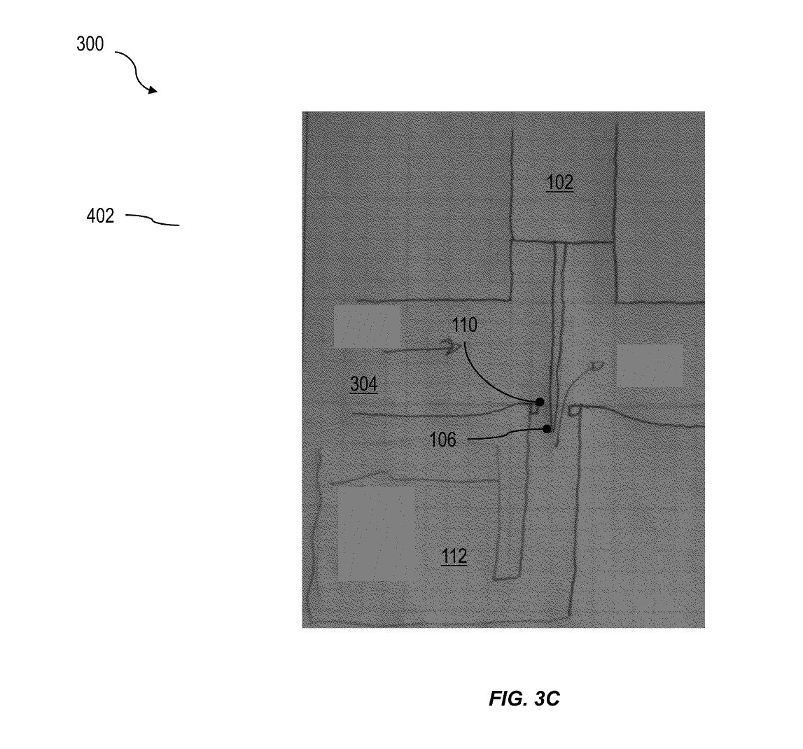

In another implementation, which can be better understood with reference to the carburetor system 300 of FIG. 3A, FIG. 3B and FIG. 3C, a throttle slide 106 can move up and down in a venturi region 302 of an air passage 304. At a low power arrangement such as is shown in FIG. 3A, the throttle slide 106 can be in a position to curtail air flow through the air passage 304. The needle 106 can be positioned in the fuel orifice 110 in a manner to leave a small gap between the circumference of the needle 106 and the inner diameter of the fuel orifice 110 such that a lean mixture, for example one with approximately 10% to 30% of excess air, can be produced.

When the slide 102 is moved upward as is shown in FIG. 3B, the air flow through the air passage 304 increases. The needle 106 and the fuel orifice 110 can remain in cooperation to provide a still restricted area for fuel flow such that a lean mixture is provided even at full throttle air flow. In one example, engine load at this setting of the carburetor 300 can be 6-7 bar BMEP (brake mean effective pressure) with a ratio of the actual air-to-fuel ratio to a stoichiometric air-to-fuel ratio (2) of approximately 1.3 to 1.6, or advantageously of about 1.4 (e.g. 40% excess air).

For further power increases beyond those achievable at full throttle with a lean combustion mixture such as is shown in FIG. 3B, the carburetor can operate in the configuration shown in FIG. 3C, in which the slide 102 can continue to lift past the position of full throttle air flow such that the needle 106 is drawn further out of the fuel orifice 110. The continuing taper of the needle 106 can produce a larger opening at the fuel orifice 110 such that the air-to-fuel ratio of the combustion mixture produced becomes increasing rich as the needle 106 is lifted upward by motion of the slide 102. In one example, the needle 106 and fuel orifice can be configured such that the air-to-fuel ratio at this setting can be approximately stoichiometric (i.e. 2, of approximately 1) or even richer than stoichiometric (i.e. 2, as low as approximately 0.8). In another example the needle of FIG. 2 can be used such that the third section is positioned in the orifice 110 when the slide is withdrawn past the position of full throttle air flow.

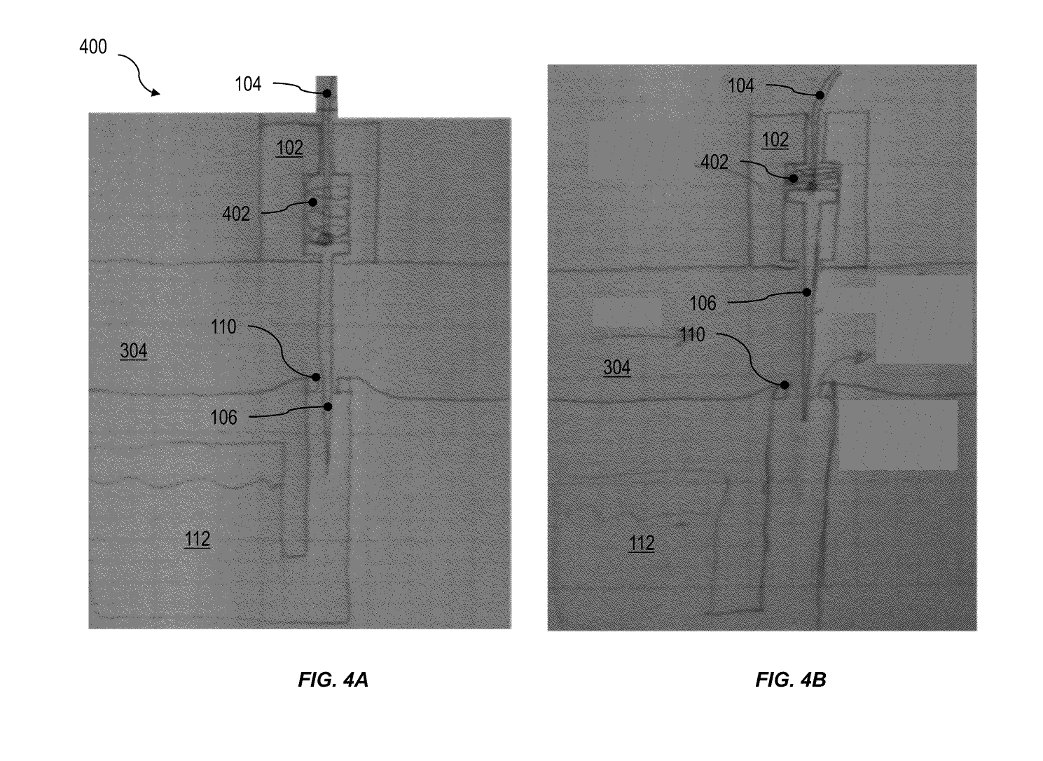

In another implementation, which can be better understood with reference to the carburetor system 400 of FIG. 4A and FIG. 4B, the needle 106 can be retractable into the slide 102. A spring 402 can be used to bias the needle 106 downward (relative to the orientation of the carburetor 400 of FIG. 4A and FIG. 4B) such that the slide 102 and needle 106 behave similarly to the configuration discussed above in reference to FIG. 3A, FIG. 3B and FIG. 3C for low power and at a full throttle air flow condition. FIG. 4A shows the slide 102 fully retracted with the needle 106 biased downward by the spring 402 such that the cross-sectional area of the fuel orifice 110 remains restricted by part of the needle 106.

As the operator of the vehicle demands additional power, the throttle cable 104 or some other control apparatus can exert additional force on the needle 106 such that the biasing force of the spring 402 is overcome and the needle 106 can retract into the body of the slide 102 as shown in FIG. 4B. In this manner, the cross-sectional area of the fuel orifice 110 is increased and greater fuel flow becomes possible such that the air-to-fuel ratio of the produced combustion mixture is enriched in a manner similar to that discussed above in reference to FIG. 3C. A difference from what is shown in FIG. 3C, however, is that the lower edge of the slide 102 can remain at least approximately flush with the wall of the air passage 304 as the mixture is further enriched such that potentially disruptive flow eddies are reduced or minimized in the vicinity of the fuel orifice 110 and the venturi region that controls the pressure drop used to pull the fuel from the fuel reservoir 112.

A conventional carburetor may have some degree of travel of the needle 106 relative to the slide 102. However, in such designs, the adjustment of fuel flow relative to air flow is made at idle or when the throttle is otherwise closed or nearly closed and is done to slightly enrich the air-to-fuel ratio at idle to achieve a smoother idle condition. In such an approach, as the slide 102 nears the closed position, the needle 106 hits a stop to maintain a certain level of enriched fuel flow through the fuel orifice 110 while the slide 102 continues to close. This approach differs from implementations of the current subject matter in which motion of the needle 106 relative to the slide 102 occurs at or near maximum air flow through the air passage 304 such that the air-to-fuel ratio can be enriched to provide higher power beyond a wide open throttle condition.

The carburetor 300 shown in each of FIG. 3A, FIG. 3B, and FIG. 3C and the carburetor 400 shown in FIG. 4A and FIG. 4B can optionally include use of the multi-section needle 106 shown in FIG. 2.

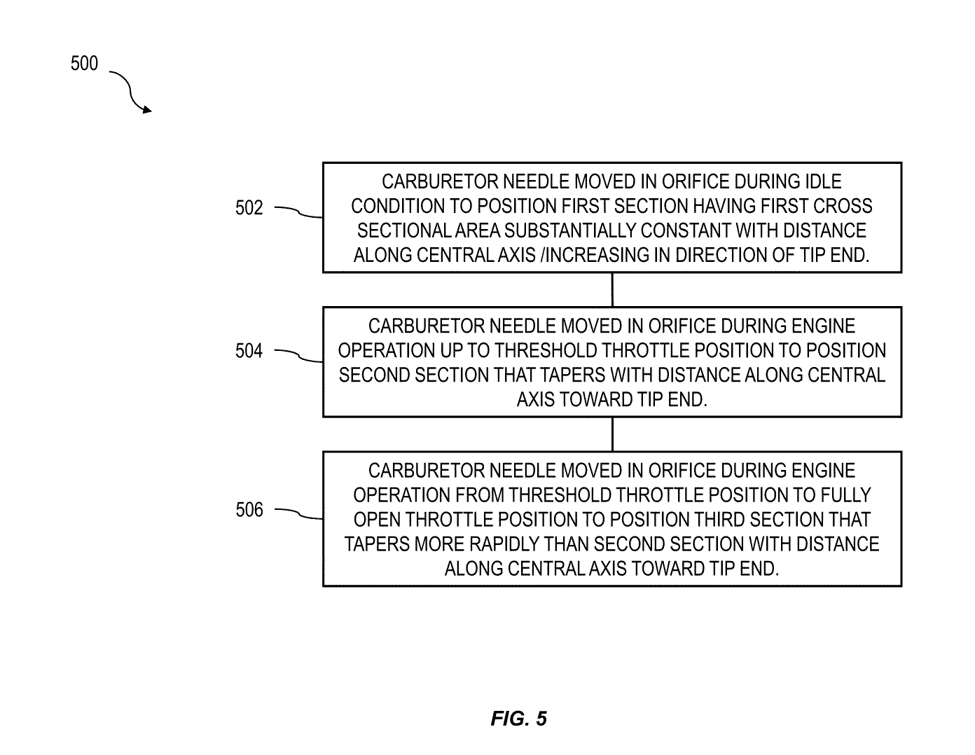

FIG. 5 shows a process flow chart 500 illustrating features of a method consistent with one or more implementations of the current subject matter. At 502, a carburetor needle is moved to position a first section of the carburetor needle within an orifice during an idle condition of an internal combustion engine. A first slope angle of the first section relative to a central axis of the carburetor needle gives the first section a first cross sectional area that is either substantially constant with distance along the central axis or increasing in a direction of a tip end of the carburetor needle. At 504, the carburetor needle is moved to position a second section of the carburetor needle within the orifice during engine operation up to a threshold throttle position of a throttle. A second slope angle of the second section relative to the central axis of the carburetor needle causes the second section to taper with distance along the central axis toward the tip end. At 506, the carburetor needle is moved to position a third section of the carburetor needle within the orifice during engine operation between the threshold throttle position and a fully open throttle position. A third slope angle of the third section relative to the central axis of the carburetor needle causes the third section to taper more rapidly than the second section with distance along the central axis toward the tip end.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A system comprising:
a carburetor needle comprising a plurality of longitudinal sections and having a tip end, the plurality comprising a first section having a first slope angle relative to a central axis of the needle, a second section having a second slope angle relative to a central axis of the needle, and a third section having a third slope angle relative to a central axis of the needle, the first slope angle giving the first section a first cross sectional area that is either substantially constant with distance along the central axis or increasing in a direction of the tip end, the second slope angle causing the second section to taper with distance along the central axis toward the tip end, and the third slope angle causing the third section to taper more rapidly than the second section with distance along the central axis toward the tip end; and
a mechanism for moving the carburetor needle into and out of a fuel orifice such that the first section is positioned in the orifice during an idle condition of an internal combustion engine, the second section is positioned in the orifice for engine operation up to a threshold throttle position of a throttle, and the third section is positioned in the orifice for engine operation between the threshold throttle position and a fully open throttle position.

2. A system as in claim 1, wherein the threshold throttle position occurs when the throttle is approximately 80% open.

3. A system as in claim 1, wherein a first combustion mixture having an approximately stoichiometric fuel-air ratio is provided when the first section is positioned in the orifice.

4. A system as in claim 1, wherein a second combustion mixture having a second fuel-air ratio that becomes progressively more lean with increased throttle opening is provided when the second section is positioned in the orifice.

5. A system as in claim 1, wherein a third combustion mixture having a third fuel-air ratio that becomes progressively richer with increased throttle opening is provided when the third section is positioned in the orifice.

6. A system as in claim 1, further comprising a feedback mechanism that indicates to a user that the third section of the carburetor needle is positioned in the orifice and that the internal combustion engine is operating in a less efficient mode than when the second section is positioned in the orifice.

7. A system as in claim 1, wherein the mechanism for moving the carburetor needle comprises a slide that moves away from the orifice to increase air flow passing over the orifice and toward the orifice to reduce air flow passing over the orifice, and wherein an attached end of the carburetor needle that is disposed opposite the tip end is attached to the slide.

8. A system as in claim 7, wherein the slide is moveable past a position providing full throttle air flow passing over the orifice such that the carburetor needle is drawn farther out of the orifice and such that the third section of the carburetor needle is positioned in the orifice.

9. A system as in claim 1, wherein the mechanism for moving the carburetor needle comprises a slide, and wherein the needle is attached to the slide such that the needle is at least partially retractable into the slide, the mechanism further comprising a spring that exerts a biasing force on the carburetor needle in a direction toward the orifice and a control apparatus that exerts additional force on the carburetor needle such that the biasing force is overcome for engine operation past the threshold throttle position.

10. A method comprising:
moving a carburetor needle to position a first section of the carburetor needle within an orifice during an idle condition of an internal combustion engine, the first section having a first slope angle relative to a central axis of the carburetor needle, the first slope angle giving the first section a first cross sectional area that is either substantially constant with distance along the central axis or increasing in a direction of a tip end of the carburetor needle;
moving the carburetor needle to position a second section of the carburetor needle within the orifice during engine operation up to a threshold throttle position of a throttle, the second section having a second slope angle relative to the central axis of the carburetor needle, the second slope angle causing the second section to taper with distance along the central axis toward the tip end; and
moving the carburetor needle to position a third section of the carburetor needle within the orifice during engine operation between the threshold throttle position and a fully open throttle position, the third section having a third slope angle relative to the central axis of the carburetor needle, the third slope angle causing the third section to taper more rapidly than the second section with distance along the central axis toward the tip end.

11. A method as in claim 10, wherein the threshold throttle position occurs when the throttle is approximately 80% open.

12. A method as in claim 10, wherein a first combustion mixture having an approximately stoichiometric fuel-air ratio is provided when the first section is positioned in the orifice.

13. A method as in claim 10, wherein a second combustion mixture having a second fuel-air ratio that becomes progressively more lean with increased throttle opening is provided when the second section is positioned in the orifice.

14. A method as in claim 10, wherein a third combustion mixture having a third fuel-air ratio that becomes progressively richer with increased throttle opening is provided when the third section is positioned in the orifice.

15. A method as in claim 10, further comprising providing feedback that indicates to a user that the third section of the carburetor needle is positioned in the orifice and that the internal combustion engine is operating in a less efficient mode than when the second section is positioned in the orifice.

16. A method as in claim 10, wherein the moving of the carburetor needle comprises operating a slide that moves away from the orifice to increase air flow passing over the orifice and toward the orifice to reduce air flow passing over the orifice, and wherein an attached end of the carburetor needle that is disposed opposite the tip end is attached to the slide.

17. A method as in claim 16, wherein the moving of the carburetor needle to position the third section of the carburetor needle within the orifice further comprises moving the slide past a position providing full throttle air flow passing over the orifice such that the carburetor needle is drawn farther out of the orifice.

18. A method as in claim 10, wherein the moving of the carburetor needle comprises operating a slide, wherein the needle is attached to the slide such that the needle is at least partially retractable into the slide, wherein a spring exerts a biasing force on the carburetor needle in a direction toward the orifice, and wherein a control apparatus exerts additional force on the carburetor needle such that the biasing force is overcome for engine operation past the threshold throttle position.
